(19) United States
(12) Patent Application Publication
(10) Pub. No.: US 2025/0363039 A1
(43) Pub. Date: Nov. 27, 2025

(54) SYSTEMS AND METHODS FOR MACHINE LEARNING MODEL TESTING

(71) Applicant: The Toronto-Dominion Bank, Toronto (CA)

(72) Inventors: Raunaq SURI, Mississauga (CA); Satya Krishna GORTI, Toronto (CA); Guangwei YU, Toronto (CA); Alexander CLARENCE, Toronto (CA); Maksims VOLKOVS, Toronto (CA); Ding Tao LIU, Toronto (CA)

(21) Appl. No.: 18/674,133

(22) Filed: May 24, 2024

(51) Int. Cl. G06F 11/36; G06F 11/34

(52) U.S. Cl. CPC G06F 11/3668; G06F 11/3466

(57) ABSTRACT

Systems and methods for fuzzy regression testing of a machine learning pipeline. The pipeline includes one or more supporting software packages and executes a machine learning model. Reference artifacts associated with the pipeline are obtained. Subsequently, one or more test script is executed to compare test artifacts generated during execution to the reference artifacts.

### TECHNICAL FIELD

The disclosed exemplary embodiments relate to computer-implemented systems and methods for regression testing and, in particular, regression testing of machine learning model pipelines.

### BACKGROUND

When deploying machine learning (ML) models in a cloud environment, a combination of supporting libraries, frameworks, and cloud services is typically used to enable the model to operate. The combination of the ML model and its supporting packages is commonly referred to as the ML pipeline. One common approach to build, train and deploy ML models and their pipelines is to utilize a cloud-based platform such as Amazon SageMaker™, Google Cloud™ Al Platform, or Microsoft Azure™ Machine Learning.

Many ML models are built in the Python programming language, for example. In this context, the ML pipelines may include Python libraries like scikit-learn, TensorFlow, or PyTorch, which are used to develop and train the machine learning model. These libraries provide pre-built functions and algorithms for tasks such as data preprocessing, feature engineering, and model training. Once the model is trained, it and its pipeline can be deployed in the cloud.

To deploy the model in the cloud, additional supporting packages may be required to handle tasks such as:
Data ingestion: Libraries like Apache Beam™ or Amazon Web Services (AWS) Glue™ are used to extract and process data from various sources.
Model serving: Frameworks like TensorFlow™ Serving or AWS SageMaker™ Hosting provide a managed environment for deploying and serving ML models.
Application programming interface (API) management: Packages like Flask-Restful or Django Rest Framework enable the creation of RESTful APIs to interact with the deployed model.

In addition to these libraries and frameworks, other packages may be required to handle specific tasks such as:
Data storage: Libraries like Pandas or NumPy are used to store and manipulate data.
Model evaluation: Packages like Scikit-Evaluate or TensorFlow's built-in evaluation metrics provide tools for evaluating the performance of ML models.

All of these supporting packages within the pipeline are discrete software projects that each may be updated from time to time. Packages may be updated to fix bugs, address security vulnerabilities, or enable new features, for example. Furthermore, each support package may have its own dependencies, i.e., one or more library, framework, or module that the supporting package (and, in turn, the ML model) relies on to function correctly. Accordingly, every deployed ML model has a dependency tree, which identifies the supporting packages and all related software dependencies.

### SUMMARY

The following summary is intended to introduce the reader to various aspects of the detailed description, but not to define or delimit any invention.

In at least one broad aspect, there is provided a system for testing a machine learning pipeline for execution of a machine learning model, wherein the machine learning pipeline includes one or more supporting package, the system including: a memory, a communication interface, and at least one processor operatively coupled to the memory and the communication interface; the at least one processor configured to execute an instruction and: obtain, via the communication interface, one or more reference artifacts associated with a first version of the machine learning pipeline; obtain one or more test artifacts generated during execution of a second version of the machine learning pipeline; compare the one or more test artifacts to the one or more reference artifacts; and generate and transmit, via the communication interface, a report based on the comparison of the one or more test artifacts to the one or more reference artifacts.

In another broad aspect, there is provided a method for testing a machine learning pipeline for execution of a machine learning model, wherein the machine learning pipeline includes one or more supporting package, the method including, based on an instruction: obtaining one or more reference artifacts associated with a first version of the machine learning pipeline; obtaining one or more test artifacts generated during execution of a second version of the machine learning pipeline; comparing the one or more test artifacts to the one or more reference artifacts; and generating and transmitting a report based on the comparing of the one or more test artifacts to the one or more reference artifacts.

In some cases, the instruction causes the at least one processor to compare a test value in the one or more test artifacts to a reference value in the one or more reference artifacts using a predetermined threshold, and the comparison may be considered successful when the test value is within the predetermined threshold of the reference value.

In some cases, the instruction causes the at least one processor to compare a test value in the one or more test artifacts to a reference value in the one or more reference artifacts using a predetermined threshold, and wherein the comparison is successful when the test value is within the predetermined threshold of the reference value.

In some cases, the instruction causes the at least one processor to compare a plurality of test values in the one or more test artifacts to a plurality of reference values in the one or more reference artifacts, and the comparison may be considered successful when a predetermined number of the plurality of test values are within a predetermined threshold.

In some cases, the instruction causes the at least one processor to compare a plurality of test values in the one or more test artifacts to a reference value in the one or more reference artifacts, and the comparison may be considered successful when a predetermined number of the plurality of test values are within a predetermined threshold.

In some cases, the plurality of test values is obtained by executing the machine learning pipeline more than once.

In some cases, the at least one processor includes a test execution processor and a pipeline execution processor that is operatively coupled to the test execution processor via the communication interface. The test execution processor may be configured to send a test execution instruction to the pipeline execution processor via the communication interface. The pipeline execution processor may be configured to execute the second version of the machine learning pipeline to generate the one or more test artifacts in response to the execution instruction.

In some cases, the one or more reference artifacts comprise a pre-processing artifact generated during pre-processing of an input artifact for input to the second version of the machine learning pipeline.

In some cases, the one or more reference artifacts include an input artifact for input to the machine learning pipeline. In some cases, the one or more reference artifacts include one or more output artifact generated by the first version of the machine learning pipeline. In some cases, the one or more output artifact includes at least one of: an inference result, a performance metric based on the one or more output artifact, and data for a downstream application.

In some cases, the one or more reference artifacts include a reference value that includes an explainability metric computed using an explainability algorithm, and the test value of the one or more test artifacts is computed using the explainability algorithm.

In some cases, the processor is configured to: obtain a pipeline configuration file associated with the machine learning pipeline and, prior to executing the instruction, detect a change in the pipeline configuration file indicating that the first version of the machine learning pipeline has been updated to the second version of the machine learning pipeline.

In some cases, the processor is configured to update the plurality of reference artifacts using the plurality of test artifacts.

In some cases, the processor is configured to update the predetermined threshold.

In some cases, the report is transmitted to a user device.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1A is a schematic block diagram of a computing system in accordance with at least some embodiments;

FIG. 1B is a schematic block diagram of a cloud-based computing cluster of FIG. 1A, in accordance with at least some embodiments;

FIG. 2 is a block diagram of a computer in accordance with at least some embodiments;

FIG. 3 is a flow chart diagram for an example process for testing a machine learning pipeline for execution of a machine learning model in accordance with at least some embodiments; and

FIGS. 4A to 4C are simplified conceptual diagrams of elements of the process of FIG. 3.

### DETAILED DESCRIPTION

Whether for a simple logistic regression model or a complex large language model (LLM) workflow, machine learning models are first trained and evaluated in a development environment (i.e., “offline”). For example, ML models may be analyzed to ensure that they operate as intended given different input data, and that both the models and their pipelines are sufficiently performant.

Further, many ML models are developed to work with very sensitive data, such as data that may have security, privacy or financial implications. In such cases, new ML models may undergo additional and extensive validation and certification process to ensure that they and their pipelines operate as intended. For example, models and pipelines may be subjected to security analysis to ensure they do not leak information in unexpected ways, bias analysis to minimize the risk of exhibiting unwanted biases, and so forth.

Once a model has sufficient offline performance and has successfully passed validation and certification, it is ready to be deployed in a “production” environment to be used against live data (e.g., “production” data).

This testing, validation and certification process may take weeks or even months and may involve multiple different tools and users. Still, ordinarily, the testing, validation and certification process focuses on the machine learning model itself and not on the supporting packages.

In many cases, deploying a model pipeline into production to run against live data is the end goal. Conventionally, ensuring the production quality of ML pipelines focuses on monitoring model performance and service health.

However, in some cases, changes to the supporting packages can also have a material impact on the performance of a machine learning model. In particular, when supporting packages are updated, they may, in some cases, materially affect the operation of a machine learning model that uses them. Some changes may be readily apparent, such as when the pipeline fails to compile. These are referred to as syntax errors. Other changes may introduce runtime errors, which is when the model and pipeline compile, but fail to run. Still other errors, which are more insidious, are logical errors, which occur when the model and pipeline successfully compile and successfully run, but silently fail, sometimes in ways that are difficult to detect. For example, there may be faults in the output.

There is an additional fault that can arise, which results in changes in the operation or performance of the machine learning model. For example, if a change to a supporting package causes the pipeline to operate 10% slower than previously, or use 10% more memory, than previously, this may represent a serious degradation if the model operates on a sufficiently large scale. This may be referred to as a performance fault.

When managing and updating ML pipelines, it may be preferable to minimize the number of interactions with ML models once the pipeline is deployed. This is both to minimize the risk of introducing the aforementioned faults and errors, and also to avoid the need to recertify or revalidate the model or pipeline. However, in practice, it may not be possible to fully avoid making changes to the pipeline. As noted, updates may be necessary to supporting packages due to security patches to the supporting packages themselves or to their dependencies. For instance, a dependency update from version 1 to version 2 can have cascading effects on the pipeline.

In conventional software development, regression tests may be used to verify that software is still operating correctly after a change has been introduced. A traditional regression test is a type of software testing that involves verifying the functionality and behavior of an application after making changes, updates, or modifications to its codebase. The primary goal of a traditional regression test is to ensure that the changes made do not introduce any new bugs or affect the existing features and functionalities of the system. Traditional regression testing may involve unit tests, which are typically numerous, with each test evaluating a small piece of the code. If each test passes, then some assurance is provided that the individual piece of code is working as intended. Alongside unit tests, there are integration tests, which test if the unit tested pieces work well together, and functional tests, which test the functionality of the software Taken together, these tests make up traditional regression testing.

In other words, a traditional regression test aims to validate that the software still behaves as expected, with no unexpected side effects or deviations from its original behavior, after introducing new code, fixing bugs, or updating dependencies.

Traditional regression tests typically involve re-running a set of pre-defined test cases, scenarios, or use cases against the updated software to verify that the expected results are still produced. This may involve testing specific features, workflows, or user interactions to confirm that they continue to function as intended.

When dealing with software that involves machine learning models, such as predictive analytics or natural language processing, traditional regression testing is more difficult due to the inherent variability of these models' output. Machine learning models may be designed to learn from data and improve their performance over time, which means that even if the same input data is provided, the model's output can change significantly. This behavior is likely well-defined but cannot be guaranteed based on the types of models, since models work on unseen data.

This is because machine learning models are inherently probabilistic, meaning they produce uncertain or fuzzy outputs rather than deterministic ones. As a result, it can be difficult to define and execute regression tests that verify specific expected outputs, as the model's behavior may have changed since the last test was run.

For instance, consider a predictive model that uses historical data to forecast future sales. Even if the same input data is provided, the model's output can change over time due to changes in market trends or consumer behavior. In this case, it becomes challenging to determine whether changes made to the software have introduced new bugs or affected its overall performance.

Furthermore, machine learning models are often trained on large datasets and can be sensitive to even small changes in the data distribution. This means that a change in the underlying data can cause the model's output to shift, making it difficult to predict what the output will be for a given input.

In this context, traditional regression testing approaches that rely on verifying specific expected outputs become less effective.

The described approach involves, among other things, taking stock of artifacts generated during the development and deployment process, when the ML model and pipeline are believed or known to be operating correctly. Thus, when a change is subsequently introduced into the ML pipeline, comparisons can be performed to determine if the outputs are within a predetermined threshold.

As used herein, an artifact refers to a product or output resulting from the development, training, testing, or deployment of a machine learning model.

An artifact can take various forms, including data used to train, test, or validate a machine learning model, as well as the trained models themselves. Additionally, artifacts may include sample data, configurations, model weights, or anything else that is used to execute the pipeline. Artifacts produced by the pipeline could include inference results, performance metrics, as well as any other information that is consumed by downstream users of the pipeline. These artifacts may be saved as reference artifacts.

In the context of machine learning, artifacts serve as a record of the development process, allowing teams to track changes, monitor performance, and make informed decisions about future developments.

During deployment, our framework runs the pipeline with the previously stored reference artifacts and generate a new set of artifacts. Users write custom regression tests that compare the newly generated artifacts against the initial reference artifacts.

The described approach involves an adapted form of regression testing for ML pipelines, which can be performed before or during deployment (or even after, if desired). The approach involves executing the pipeline using previously stored reference artifacts, and generating new artifacts for comparison. Users may create custom tests, called ML regression tests, which compare the newly generated artifacts against the reference artifacts. The regression tests may use specific thresholds to validate the performance of the system. These tests can take into account the inherently statistical and fuzzy outputs of ML models, particularly when the entire pipeline comprising pre-processing, inferencing, and post-inferencing stages can undergo changes with updates, which in turn affect the overall output. As used herein, the term “regression tests” refers to ML regression tests rather than traditional regression tests, unless specified otherwise.

Regression tests can be defined at any point within the pipeline to ensure that the system remains stable and functional. Since machine learning models are not fully deterministic, a best effort approach may be employed. For example, regression tests may define a predetermined range or threshold within which output is acceptable. In some cases, these predetermined ranges or thresholds may be automatically determined using, e.g., heuristic evaluations of testing data. In other cases, they may be user-specified.

Users may define their own regression tests in the form of scripts (e.g., Python code) to facilitate these types of flexible comparisons. In some cases, baseline or default regression test scripts may be provided that can be extended by users. Moreover, users may define their comparators for the reference and newly generated artifacts.

In an example, one regression test may take an XGboost tree as an input and compare it with a baseline XGboost tree obtained using test data. The regression test may analyze the similarity of the XGboost trees and obtain a metric of their similarity or difference. The XGboost tree outputs may be in the form of binary files, therefore the regression test may involve loading the trees to facilitate the comparison. XGBoost models may also be compared using their booster JavaScript Object Notation (JSON) files. In another example, a test may compare the evaluated results DataFrame from the reference artifacts against the newly generated artifacts. If the data involves floating point numbers, a tolerance may be used to allow for expected deviation.

An example of a regression test script that loads model output in the form of a Pandas data artifact and compares it to a reference artifact may be as follows:

```
# in framework code
class PandasDataArtifact:
  def _{——}init_{——}(self, data):
  self.data = data
  def get_data(self):
  return self.data
class ArtifactLoader:
  def _{——}init_{——}(self):
  # external dependency
  self.loader_client = LoaderClient( )
  def load(self, pipeline_id, artifact_id):
  return self.loader_client.load(pipeline_id, artifact_id)
# conftest.py
import pytest
def pytest_addoption(parser):
  parser.addoption(“--pipeline_id”, action=“store”, default=“”)
@pytest.fixture
def pipeline_id(request):
  return request.config.getoption(“pipeline_id”)
@pytest.fixture
def reference_pipeline_id( ):
  return “123” # defined as a part of user code
@pytest.fixture
def artifact_loader( ):
  return ArtifactLoader( )
# test_regression.py
import pytest
import pandas.testing as pdt
def test_regression_evaluated_results_from_model(artifact_loader,
pipeline_id, reference_pipeline_id):
  reference_results = artifact_loader.load(reference_pipeline_id,
“evaluation_results”).get_data( )
  generated_artifact = artifact_loader.load(pipeline_id,
“evaluation_results”).get_data( )
  pdt.assert_frame_equal(reference_results, generated_artifact,
rtol=1e−3, atol=1e−3)
def test_regression_other_tests(artifact_loader, pipeline_id,
reference_pipeline_id):
  # other test
  pass
```

In addition to outputs, metrics such as the number of evaluations that fall outside predetermined bounds can also be used to evaluate the performance of the system. Furthermore, if explainability metrics are available, they also may be used to identify deviations in model output. An explainability metric refers to a quantifiable measure used to evaluate and interpret the decision-making processes of a trained ML model. Such metrics are designed to provide insight into the internal workings of the model, allowing users to better understand how the model arrives at its predictions or classifications. This transparency is useful in applications where model decisions can have significant consequences, such as medical diagnosis or financial risk assessment. Explainability metrics may involve calculating and comparing various features or attributes that contribute to the model's output. For instance, a metric might quantify the relative importance of different input variables, highlighting which factors most significantly influence the model's predictions.

Since the output of ML models and their pipelines can change over time, the artifacts used for regression testing may also be updated over time, or even each time the regression test is performed. In some cases, the regression tests themselves may be updated from time to time, e.g., to relax or tighten thresholds or introduce new tests.

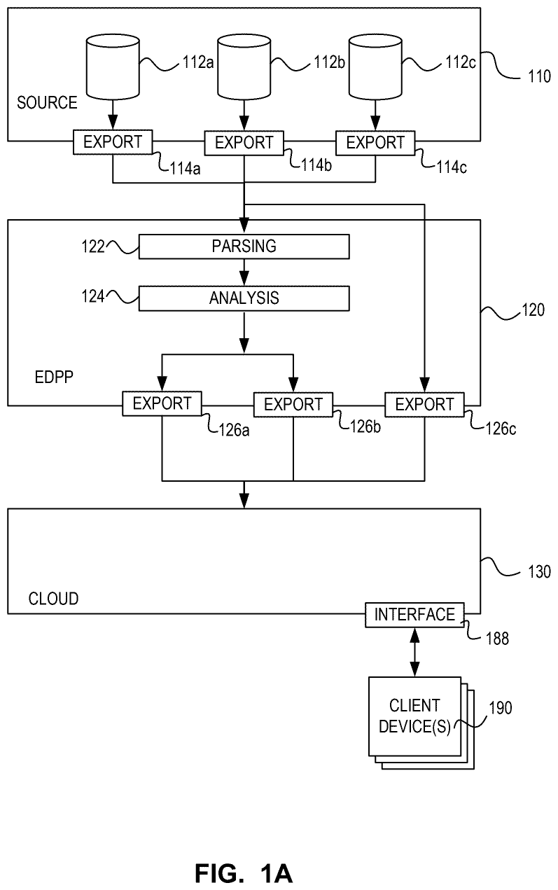

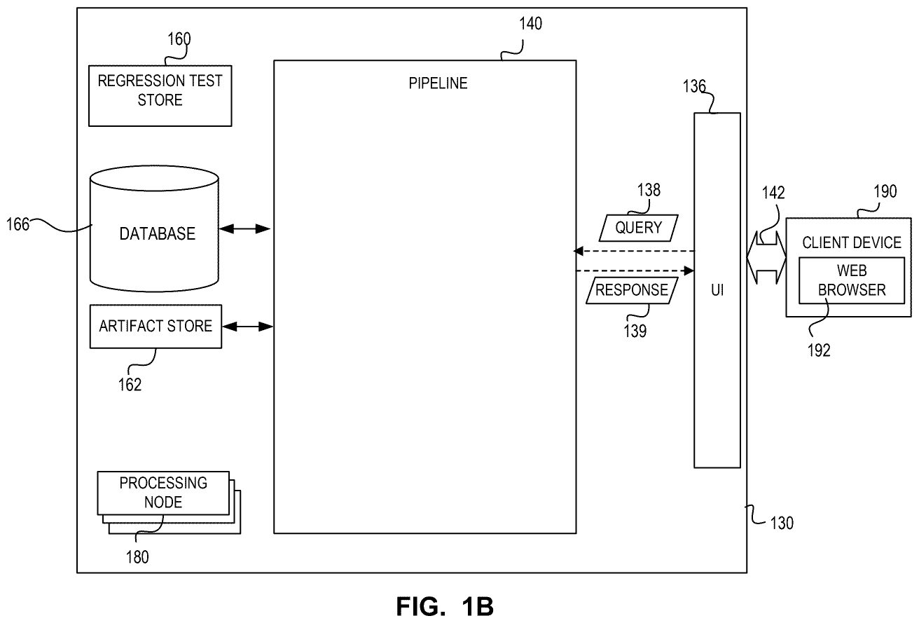

Referring now to FIG. 1A, there is illustrated a block diagram of an example computing system, in accordance with at least some embodiments. Computing system 100 has a source database system 110, an enterprise data provisioning platform (EDPP) 120 operatively coupled to the source database system 110, and a cloud-based computing cluster 130 that is operatively coupled to the EDPP 120. In some cases. this computing system 100 is provided for automated data processing of large data sets, including identify relevant documents to automatically generate responses in relation to a given query. In some cases, the documents are files that include text. In some cases, different data formats of documents or files (or both), and which include text, can be used in the computing system described herein.

Source database system 110 has one or more databases, of which three are shown for illustrative purposes: database 112a, database 112b and database 112c. One or more the databases of the source database system 110 may contain confidential information that is subject to restrictions on export. One or more export modules 114a, 114b, 114c may periodically (e.g., daily, weekly, monthly, etc.) export data from the databases 112a, 112b, 112c to EDPP 120. In some instances, the data is exported on an ad hoc basis.

EDPP 120 receives source data exported by the export modules 114 of source database system 110, processes it and exports the processed data to an application database within the cloud-based computing cluster 130. For example, a parsing module 122 of EDPP 120 may perform extract, transform and load (ETL) operations on the received source data.

In many environments, access to the EDPP may be restricted to relatively few users, such as administrative users. However, with appropriate access permissions, data relevant to a document or group of documents (e.g., a client document) may be exported via reporting and analysis module 124 or an export module 126. In particular, parsed data can then be processed and transmitted to the cloud-based computing cluster 130 by a reporting and analysis module 124. Alternatively, one or more export modules 126a, 126b, 126c can export the parsed data to the cloud-based computing cluster 130.

In some cases, there may be confidentiality and privacy restrictions imposed by governmental, regulatory, or other entities on the use or distribution of the source data. These restrictions may prohibit confidential data from being transmitted to computing systems that are not “on-premises” or within the exclusive control of an organization, for example, or that are shared among multiple organizations, as is common in a cloud-based environment. In particular, such privacy restrictions may prohibit the confidential data from being transmitted to distributed or cloud-based computing systems, where it can be processed by machine learning systems, without appropriate anonymization or obfuscation of personal identifiable information (PII) in the confidential data. Moreover, such “on-premises” systems typically are designed with access controls to limit access to the data, and thus may not be resourced or otherwise suitable for use in broader dissemination of the data. In some cases, to comply with such restrictions, one or more module of EDPP 120 may “de-risk” data tables that contain confidential data prior to transmission to cloud-based computing cluster 130. In some cases, this de-risking process may obfuscate or mask elements of confidential data, or may exclude certain elements, depending on the specific restrictions applicable to the confidential data. The specific type of obfuscation, masking or other processing is referred to as a “data treatment.”

The cloud-based computing cluster 130 includes an interface 188, which facilitates data communication with one or more client devices.

In some environments, the EDPP may be omitted.

Referring now to FIG. 1B, there is illustrated a block diagram of the cloud-based computing cluster 130, showing greater detail of the elements of the cloud-based computing cluster, which may be implemented by computing nodes of the cluster that are operatively coupled.

The components of the cloud-based computing cluster 130 include a ML pipeline 140, an optional user interface (UI) 136, a regression test store 160, an artifact store 162, and a database 166, which in some cases are implemented as one or more processing nodes 180 in the cloud-based computing cluster. In some cases, these components are implemented as virtual machines within the cloud-based computing cluster.

Pipeline 140 is not limited to the shown configuration and may, instead, be configured to perform a variety of different tasks using a variety of different models. In some cases, pipeline 140 may be non-interactive (e.g., executes based on a schedule, or on demand in response to other workflows), in which case UI 136 and client device 190 may be omitted.

Regression test store 160 is a database that stores one or more ML regression tests as described herein, which may be executed by one or more processing node 180 before, during or after a deployment process for pipeline 140. Likewise, artifact store 162 is a database that stores reference artifacts and newly-generated artifacts generated by the regression tests.

Database 166 stores data used by pipeline 140, including any other artifacts used or generated by pipeline 140. In some cases, database 166 may incorporate regression test store 160 and/or artifact store 162.

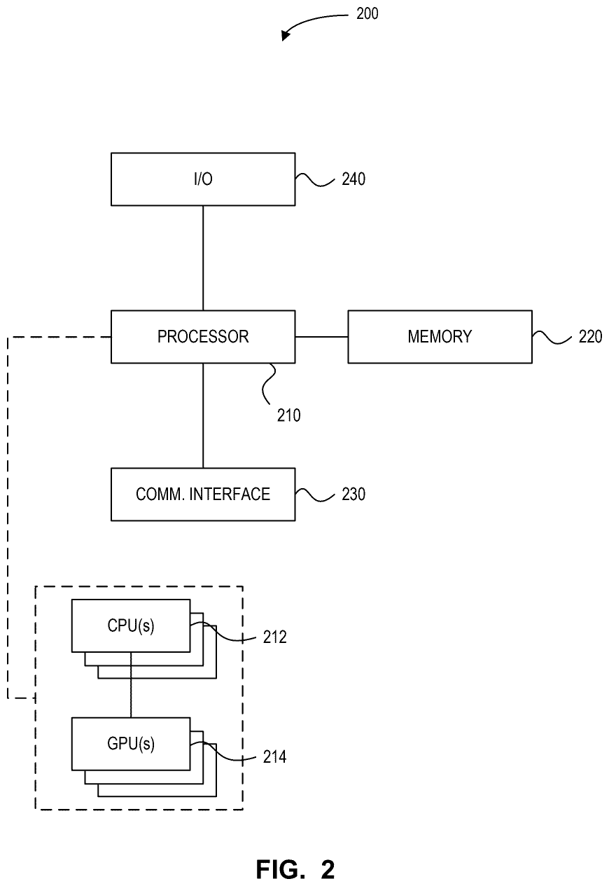

Referring now to FIG. 2, there is illustrated a simplified block diagram of a computer 200 in accordance with at least some embodiments. The computer 200 is also herein interchangeably called a computing system. Computer 200 is an example implementation of a computer such as source database system 110, EDPP 120, processing node 180 of FIGS. 1A and 1B. Computer 200 has at least one processor 210 operatively coupled to at least one memory 220, at least one communications interface 230 (also herein called a network interface), and at least one input/output device 240.

The at least one memory 220 includes a volatile memory that stores instructions executed or executable by processor 210, and input and output data used or generated during execution of the instructions. Memory 220 may also include non-volatile memory used to store input and/or output data—e.g., within a database—along with program code containing executable instructions.

Processor 210 may transmit or receive data via communications interface 230, and may also transmit or receive data via any additional input/output device 240 as appropriate.

In some cases, the processor 210 includes a system of central processing units (CPUs) 212. In some other cases, the processor includes a system of one or more CPUs and one or more Graphical Processing Units (GPUs) 214 that are coupled together. For example, the secondary LLM 170 executes neural network computations on CPU and GPU hardware, such as the system of CPUs 212 and GPUs 214.

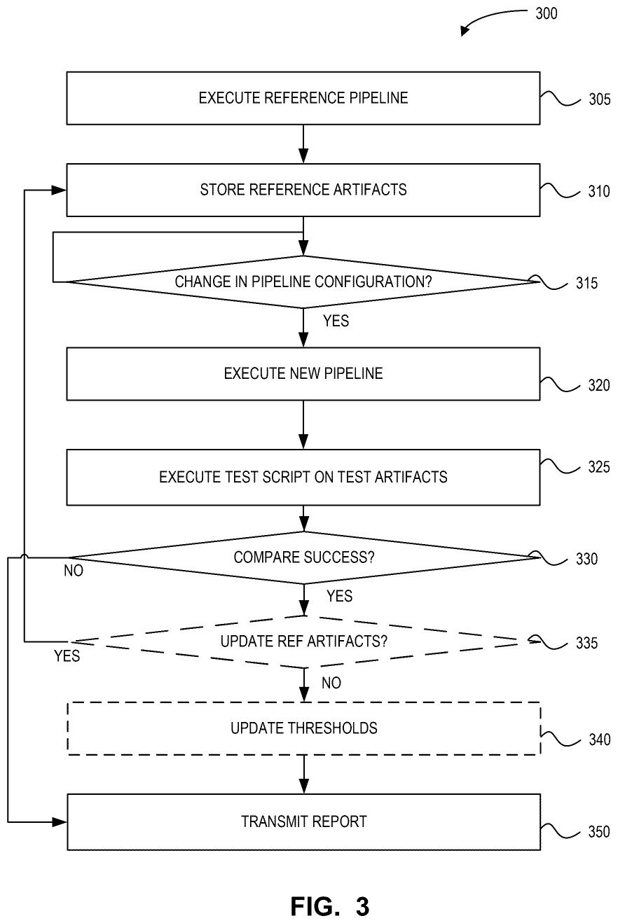

Referring now to FIG. 3, there is illustrated a flow chart diagram for an example process for testing a machine learning pipeline for execution of a machine learning model. Process 300 may be performed by one or more computers 200, such as a cloud-based computing cluster 130 of FIGS. 1A and 1B. In some example implementations, there may be a text execution processor that carries out process 300 in conjunction with, or based on the output of, a pipeline execution processor. For example, the test execution processor may instruct the pipeline execution processor to generate one or more test artifacts as described below.

Process 300 begins at block 305, with the execution of a first version of the ML pipeline, which may include one or more supporting package that is also executed. As used in this context, the term ‘first version’ may refer to an initial version of the ML pipeline, or a subsequent version that has been used to generate reference artifacts. The execution of the first version of the ML pipeline generates one or more reference artifacts, and may occur during an offline or development stage, prior to deployment of the newest version of the ML pipeline. Alternatively, in some cases, the execution of the ML pipeline takes place following deployment, particularly if reference artifacts where not generated prior to deployment.

Reference artifacts may include sample input data to the machine learning pipeline and sample output data from the model and/or pipeline. The sample output data may include, e.g., inferences or predictions generated by the first version of the pipeline, performance metrics based on output of the first version of the pipeline, and data for a downstream application generated by the first version of the pipeline.

Reference artifacts may include reference values, which can be alphanumeric in nature. In some cases, a reference value may include or be an explainability metric computed using an explainability algorithm. In such cases, the corresponding test artifact may comprise a test value computed using the explainability algorithm.

In some cases, the one or more reference artifacts may include pre-processing artifacts drawn from pre-processing of input data (e.g., input artifacts) prior to ingestion into the ML model in the machine learning pipeline.

At block 310, the one or more reference artifacts associated with the first version of the machine learning pipeline are stored in an artifact store.

At block 315, a change in the configuration of the pipeline is detected. For example, a node or monitoring process may periodically check a configuration associated with the pipeline to determine if the pipeline configuration has changed. Alternatively, the configuration may be stored in a file, such as a plaintext file or JSON file, and may identify—among other things—each of the supporting packages used in the pipeline, along with their respective version numbers. The configuration file may also identify a version of the model itself. Accordingly, if any version number has changed since the ML regression test was executed (or last successfully executed), the process may proceed to block 320. Otherwise, the process may continue to monitor for changes.

At block 320, the pipeline is executed using a second version of the ML pipeline to generate one or more test artifacts. As used in this context, the term ‘second version’ refers to the updated configuration of the ML pipeline resulting from the updates to the ML model or the supporting packages. The one or more test artifacts may be output form the machine learning model, such as inferences or predictions, generated based on reference input artifacts, such that the output test artifacts are anticipated to closely resemble the output reference artifacts. The test artifacts may also be other types of artifacts, such as explainability metrics or aggregated data.

At block 325, a test script is executed to compare the one or more test artifacts to the one or more reference artifacts.

In some cases, the test script compares a test value in the one or more test artifacts to a reference value in the one or more reference artifacts using a predetermined threshold. The comparison may be considered successful when the test value is within the predetermined threshold of the reference value.

In some cases, the test script compares a plurality of test values in the one or more test artifacts to a plurality of reference values in the one or more reference artifacts. The comparison may be considered successful when a predetermined number of the plurality of test values are within the predetermined threshold.

In some cases, the test script the test script compares a plurality of test values in the one or more test artifacts to a reference value in the one or more reference artifacts. The comparison may be considered successful when a predetermined number of the plurality of test values are within the predetermined threshold. In some cases, the plurality of test values can be obtained by executing the machine learning pipeline more than once.

In some cases, blocks 320 and 325 may be merged. For example, the test script may itself cause the execution of the pipeline to generate the test artifacts.

At block 330, if the comparison was successful, the process may proceed to block 335 to update one or more reference artifacts, if desired.

Similarly, at block 340, one or more predetermined threshold or number may be updated, if desired.

At block 350, a report of the test script's execution may be generated and transmitted to a user device, another node of the computing cluster, or a database. For example, the report may indicate whether the test script successfully executed one or more comparisons, of if any errors or warnings were encountered. In some cases, further action may be taken automatically, such as disabling the pipeline in the event of a warning or error being detected.

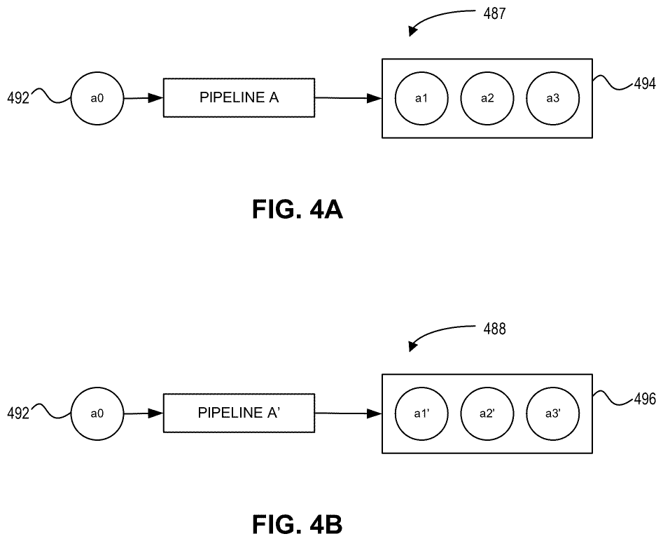

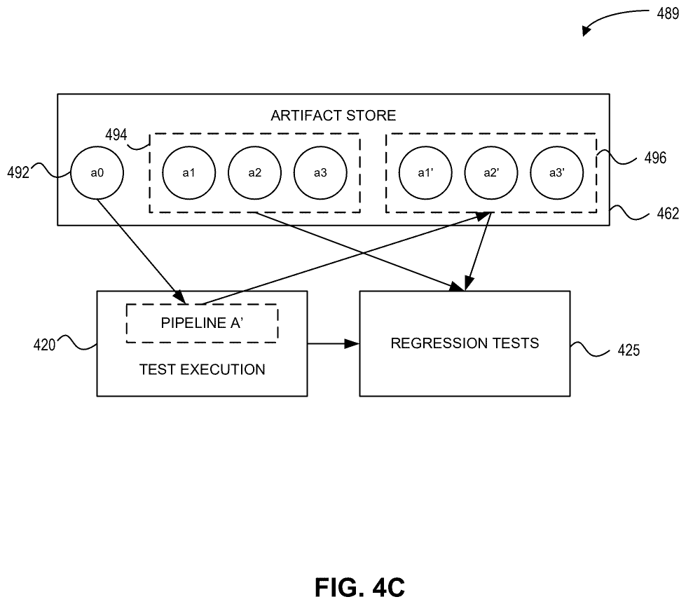

Referring now to FIGS. 4A to 4C, there are illustrated simplified conceptual diagrams of elements of the process of FIG. 3. As with process 300, processes 487, 488 and 489 may be performed by one or more computers 200, such as a cloud-based computing cluster 130 of FIGS. 1A and 1B.

Process 487 may be performed on the initial execution of the ML pipeline, to generate reference artifacts. Sample input data 492, which may itself be a reference artifact, is provided to the pipeline A for execution, and one or more reference artifacts 494 are generated.

Process 488 illustrates a test execution process conceptually. Input reference artifact 492 is provided to the updated pipeline A′ for execution, where the prime denotes a change from an initial pipeline A, and one or more test artifacts 496 are generated.

Process 489 illustrates the regression test process. Artifact store 462 stores one or more reference artifacts 492 and 494, and one or more test artifacts 496, which are generated by execution of a pipeline A′. Pipeline A′ is executed using input reference artifact 492, and produces test artifacts 496. Following execution of pipeline A′, regression tests 425 may be performed using reference artifacts 494 and test artifacts 496.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g. a pushbutton keyboard, mouse, a touchscreen, and the like), and at least one output device (e.g. a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A system for testing a machine learning pipeline for execution of a machine learning model, wherein the machine learning pipeline includes one or more supporting package, the system comprising:
a memory, a communication interface, and at least one processor operatively coupled to the memory and the communication interface;
the at least one processor configured to execute an instruction to:
obtain, via the communication interface, one or more reference artifacts associated with a first version of the machine learning pipeline;
obtain one or more test artifacts generated during execution of a second version of the machine learning pipeline;
compare the one or more test artifacts to the one or more reference artifacts; and
generate and transmit, via the communication interface, a report based on the comparison of the one or more test artifacts to the one or more reference artifacts.

2. The system of claim 1, wherein the instruction causes the at least one processor to compare a test value in the one or more test artifacts to a reference value in the one or more reference artifacts using a predetermined threshold, and wherein the comparison is successful when the test value is within the predetermined threshold of the reference value.

3. The system of claim 1, wherein the instruction causes the at least one processor to compare a plurality of test values in the one or more test artifacts to a plurality of reference values in the one or more reference artifacts, and wherein the comparison is successful when a predetermined number of the plurality of test values are within a predetermined threshold.

4. The system of claim 1, wherein the instruction causes the at least one processor to compare a plurality of test values in the one or more test artifacts to a reference value in the one or more reference artifacts, and wherein the comparison is successful when a predetermined number of the plurality of test values are within a predetermined threshold.

5. The system of claim 4, wherein the plurality of test values is obtained by executing the second version of the machine learning pipeline more than once.

6. The system of claim 1, wherein the at least one processor includes a test execution processor and a pipeline execution processor that is operatively coupled to the test execution processor via the communication interface.

7. The system of claim 6, wherein the test execution processor is configured to send a test execution instruction to the pipeline execution processor via the communication interface, and wherein the pipeline execution processor is configured to execute the second version of the machine learning pipeline to generate the one or more test artifacts in response to the execution instruction.

8. The system of claim 1, wherein the one or more reference artifacts comprise a pre-processing artifact generated during pre-processing of an input artifact for input to the first version of the machine learning pipeline.

9. The system of claim 1, wherein the one or more reference artifacts comprise an input artifact for input to the machine learning pipeline.

10. The system of claim 1, wherein the one or more reference artifacts comprise one or more output artifact generated by the first version of the machine learning pipeline.

11. The system of claim 10, wherein the one or more output artifact includes at least one of: an inference result, a performance metric based on the one or more output artifact, and data for a downstream application.

12. The system of claim 1, wherein the one or more reference artifacts include a reference value that includes an explainability metric computed using an explainability algorithm, and wherein a test value of the one or more test artifacts is computed using the explainability algorithm.

13. The system of claim 1, wherein the processor is configured to: obtain a pipeline configuration file associated with the machine learning pipeline and, prior to executing the instruction, detect a change in the pipeline configuration file indicating that the first version of the machine learning pipeline has been updated to the second version of the machine learning pipeline.

14. The system of claim 1, wherein the processor is configured to update the one or more reference artifacts using the one or more test artifacts.

15. The system of claim 2, wherein the processor is configured to update the predetermined threshold.

16. The system of claim 1, wherein the report is transmitted to a user device.

17. A method for testing a machine learning pipeline for execution of a machine learning model, wherein the machine learning pipeline includes one or more supporting package, the method comprising, based on an instruction:
obtaining one or more reference artifacts associated with a first version of the machine learning pipeline;
obtaining one or more test artifacts generated during execution of a second version of the machine learning pipeline;
comparing the one or more test artifacts to the one or more reference artifacts; and
generating and transmitting a report based on the comparing of the one or more test artifacts to the one or more reference artifacts.

18. The method of claim 17, further comprising: obtaining a pipeline configuration file associated with the machine learning pipeline and, prior to obtaining the one or more test artifacts, detecting a change in the pipeline configuration file indicating that the first version of the machine learning pipeline has been updated to the second version of the machine learning pipeline.

19. A non-transitory computer readable medium storing computer executable instructions which, when executed by at least one processor, cause the at least one processor to carry out a method for testing a machine learning pipeline for execution of a machine learning model based on an instruction, wherein the machine learning pipeline includes one or more supporting package, the method comprising:
obtaining one or more reference artifacts associated with a first version of the machine learning pipeline;
obtaining one or more test artifacts generated during execution of a second version of the machine learning pipeline;
comparing the one or more test artifacts to the one or more reference artifacts; and
generating and transmitting a report based on the comparing of the one or more test artifacts to the one or more reference artifacts.
